(19) United States
(12) Patent Application Publication
(10) Pub. No.: US 2012/0067110 A1
(43) Pub. Date: Mar. 22, 2012

(54) VENTED FUEL SENSOR

(75) Inventor: Herbert Perten, Suffern, NY (US)

(73) Assignee: StarTrak Information Technologies, LLC, Fort Lee, NJ (US)

(21) Appl. No.: 13/240,260

(22) Filed: Sep. 22, 2011

Related U.S. Application Data
(60) Provisional application No. 61/385,549, filed on Sep. 22, 2010.

(51) Int. Cl. G01N 11/00

(52) U.S. Cl. 73/53.01

(57) ABSTRACT

A vented fuel sensor comprising a fitting arranged to be mounted to a mating fitting on a fuel tank associated with a hole in the fuel tank, a fuel sensing mechanism, a sensor head extending from the fitting, including sensor electronics coupled to the fuel sensing mechanism and a cavity, the vented fuel sensor having an interior passage configured to interconnect the cavity with the interior of the fuel tank when the vented fuel sensor is installed on the fuel tank.

This application is related to and claims priority from U.S. provisional patent application Ser. No. 61/385,549 filed Sep. 22, 2010, the entirety of which is incorporated by reference as if fully set forth herein.

### BACKGROUND

The Federal Motor Carrier Safety Administration regulation §393.67 requires that commercial motor vehicle fuel tanks must include a no spill air vent that limits leaking in the event the vehicle overturns. Most long-distance refrigerated transport by truck is done via tractor-trailer trucks in which the tractor pulls a refrigerated semi-trailer, or “reefer”. Reefers are generally equipped with a mechanical refrigeration system powered by small displacement diesel engine. Commonly, the fuel for the engine is carried in a vented fuel tank attached to the bottom of the trailer, for example, using a bracket, yoke, or strap arrangement that holds the tank in a fixed position in close proximity to the trailer. Typically, the vent is installed by screwing it into a threaded hole in the tank provided for that purpose. When a fuel sensor is added to this type of tank, it is convenient to remove the vent, and screw the fuel sensor into the same hole that was previously occupied by the vent. This avoids the need to drill an additional hole in the tank which at best takes extra time and at worst may compromise the safety and certification of the tank. In the prior art, the vent is typically relocated when the fuel sensor is installed in the tank vent hole. Without drilling an additional hole, the prior art solution is to replace the fuel filler cap with one that contains an integral vent. Such caps are expensive and may also inadvertently be replaced with non-vented caps, resulting in a non-vented tank. This could cause the engine to stall when the internal tank pressure reaches a critical point and starves the engine of fuel.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a simplified representation of a reefer unit.

FIG. 2 presents diagrammatic views of a fuel tank.

FIG. 3 is a schematic diagram of an embodiment of a vented fuel sensor in accordance with the herein disclosed apparatus.

FIG. 4 presents diagrammatic views of a fuel tank with vented fuel sensor and vent installed.

FIG. 5 is a schematic diagram of another embodiment of a vented fuel sensor.

FIG. 6 presents diagrammatic views of a flange-mounted vented fuel sensor.

### DETAILED DESCRIPTION

Reference will now be made in detail to various embodiments of the present invention, example of which is illustrated in the accompanying drawings.

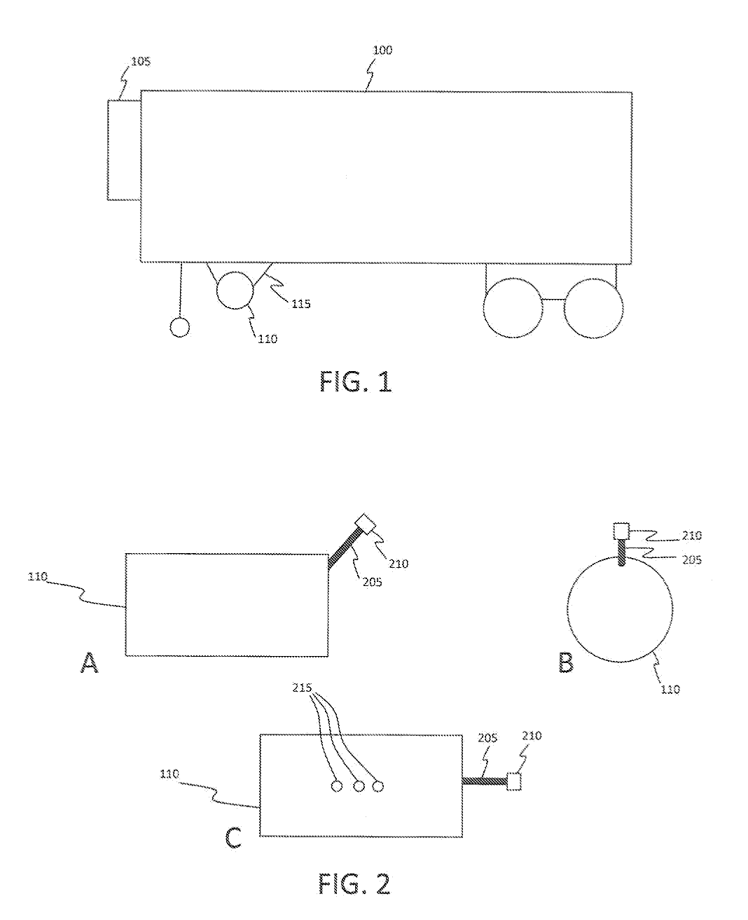

FIG. 1 is a simplified representation of a refrigerated semi trailer, or “reefer.” It includes a trailer (100) equipped with a refrigeration unit (105). The refrigeration unit comprises a diesel engine supplied with fuel from a fuel tank (110). The tank is typically mounted to the bottom of the trailer with some sort of bracket, yoke, or strap (115). Fuel tanks used in the United States are typically circular cylinders 22″ diameter, and are mounted approximately six inches below the bottom of the trailer. The figures show a cylindrical tank with its axis oriented horizontally, as would normally be the case when the tank is attached to a trailer, although tanks having other shapes or orientations may be used.

FIG. 2 gives more detailed views of tank (110), including a side view (A), end view (B), and top view (C). The tank includes a fill tube (205) equipped with a cap (210). Threaded holes (215) having female threads are provided at the top of the tank. Although three holes are shown, more or fewer holes may be included. Generally, two holes are used to attach engine fuel supply and return tubes. A screw-in vent is commonly installed in another of the holes. One such vent is described in Keller U.S. Pat. No. 4,274,431, although other vents may be used.

In an embodiment, the fuel sensor's head is provided with a threaded hole with female threads into which the tank vent can be screwed, thereby allowing the former tank vent hole or fitting to serve both the fuel sensor and the tank vent.

FIG. 3 shows an exemplary embodiment of a fuel sensor (300) in accordance with the herein disclosed apparatus. Sensor head (305) contains interface electronics (310) and termination (315) for connecting wiring (connectorized or pigtail) to the sensor. Alternatively, a wireless, self-powered sensor could also be used, in which case termination (315) could be eliminated, and other elements included, such as a signal transmitter (not shown), battery (not shown), etc. The sensor includes a threaded fitting (320) with male threads that is screwed into a threaded hole or fitting in the tank with female threads. Depending on the sensor technology used, the fuel sensor may or may not comprise down tube (325). The sensor also provides a hole (330) for venting the fuel tank. In this exemplary embodiment, this hole includes female threads (335) into which a tank vent may be screwed. In a typical installation, this vent may be the one which was removed to make room for the fuel sensor. Thus, the original fuel tank vent may be reused, even though its hole has been reassigned to use by the fuel sensor. Alternatively, the hole in the sensor may be part of a vent incorporated directly into the sensor head (305), as will be described.

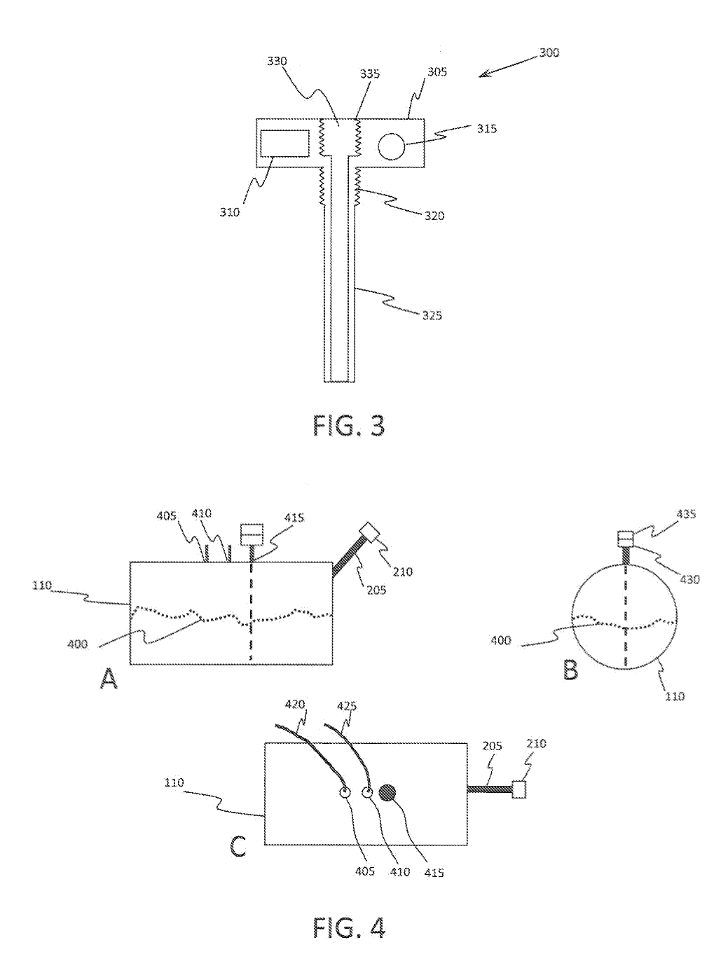

FIG. 4 shows side, end, and top views (A, B, and C, respectively) of a tank with a fuel sensor and vent, both installed using a single hole in a fuel tank, in accordance with the herein disclosed apparatus. The tank and views are similar to those shown in FIG. 2. The fuel level in the tank is indicated by dotted line (400). Fuel supply and return tubes (420, 425) are coupled to the tank at holes (405) and (410). The fuel sensor (430) and vent (435) are both installed using hole (415). Other connection arrangements may also be used. Though a fuel level sensor with a down tube is shown, the fuel sensor could also be one that does not include a down tube.

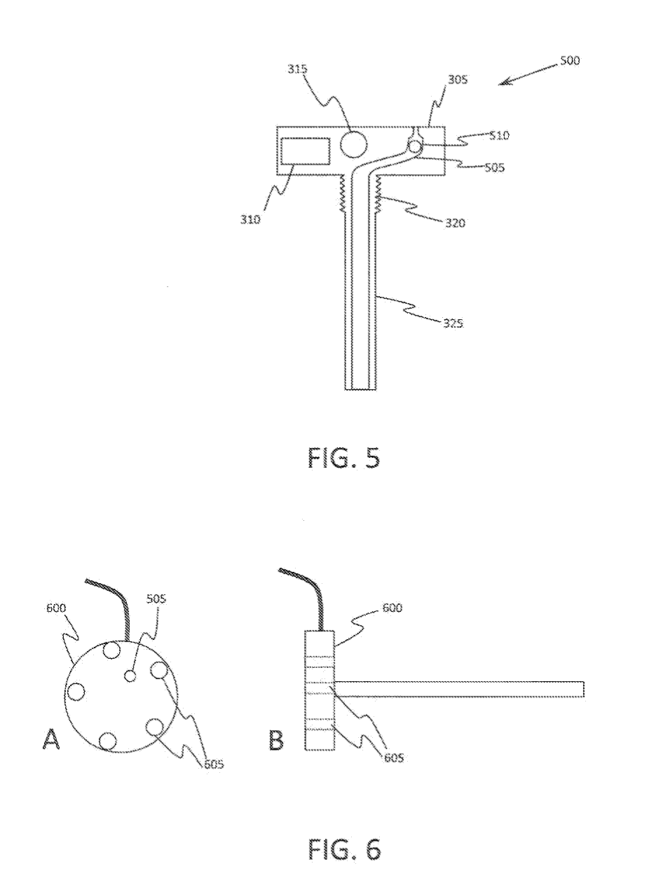

FIG. 5 is a schematic of an alternative exemplary embodiment of the vented fuel sensor, in which the vent is incorporated directly into the fuel sensor. Any type of prior art vent can be incorporated into the fuel sensor head. For example, fuel sensor 500 is similar to the sensor shown in FIG. 3, with the difference being that there is an actual vent channel 505 molded into the sensor head. This channel is configured to capture a ball 510 which quiescently falls down to an area of the channel where it does not restrict the venting. Should the trailer overturn, the ball will roll to a position so as to stop the leakage of fuel through the vent. The advantage to this embodiment is that a separate fuel tank vent does not have to be sourced, resulting in lower cost and fewer discrete parts. In addition, this embodiment has a lower profile because the vent is integral to the fuel sensor, rather than being screwed into its top. However, this embodiment does not allow the user to realize an advantage of re-using the existing fuel vent, which is that the sensor does not have to be recertified as meeting venting and spillage standards since it re-uses an already certified component.

FIG. 6 shows top (A) and side (B) views of a flange-mounted vented fuel sensor. This sensor differs from those illustrated in FIGS. 3 and 5 in the manner of attachment of the mounting head 600 to the fuel tank. In this case, the fuel tank must be equipped with mounting flange with threaded holes, and the sensor is mounted to it with threaded bolts that pass through holes (605) in the mounting head. Sensors of this type typically use a 5 hole pattern. Other mounting arrangements may also be used.

Various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A vented fuel sensor comprising:
a fitting arranged to be mounted to a mating fitting on a fuel tank associated with a hole in the fuel tank;
a fuel sensing mechanism;
a sensor head extending from the fitting, including sensor electronics coupled to the fuel sensing mechanism and a cavity;
the vented fuel sensor having an interior passage configured to interconnect the cavity with the interior of the fuel tank when the vented fuel sensor is installed on the fuel tank.

2. The vented fuel sensor of claim 1, wherein the fitting comprises threads that screw into mated threads in the fuel tank fitting.

3. The vented fuel sensor of claim 1, wherein the fitting comprises a flange that is bolted to a mated flange of the fuel tank fitting.

4. The vented fuel sensor of claim 1, wherein the cavity has female threads adapted to receive male threads of a fuel tank vent.

5. The vented fuel sensor of claim 1, wherein the cavity is part of a fuel tank vent incorporated into the sensor head.

6. The vented fuel sensor of claim 1, further comprising a termination for connecting wiring to the sensor.

7. The vented fuel sensor of claim 1, further comprising a down tube arranged to extend from the threaded fitting into the interior of the fuel tank when the sensor is installed on the fuel tank.

8. The vented fuel sensor of claim 1, wherein the passage extends through the sensor head and the fuel sensing mechanism.

9. The flexible fuel sensor of claim 1, wherein the sensor electronics in the sensor head include a signal sending unit coupled to wires for sending a signal indicating a fuel status to a gauge.

10. The flexible fuel sensor of claim 1, wherein the sensor electronics in the sensor head include a wireless transmitter for sending a signal indicating a fuel status to a gauge.

11. The flexible fuel sensor of claim 1, further comprising a battery providing power to the sensor electronics in the sensor head.
